(19) United States
(12) Patent Application Publication
(10) Pub. No.: US 2026/0163424 A1
(43) Pub. Date: Jun. 11, 2026

(54) ROTOR, MANUFACTURING ASSEMBLY FOR PRODUCING A ROTOR, METHOD FOR PRODUCING A ROTOR, AND ELECTRIC MACHINE

(71) Applicant: Schaeffler Technologies AG & Co. KG, Herzogenaurach (DE)

(72) Inventor: Moritz Wagenblatt, Erfweiler (DE)

(21) Appl. No.: 19/113,820

(22) PCT Filed: Aug. 29, 2023
(86) PCT No.: PCT/DE2023/100626

§ 371 Date: Mar. 20, 2025

(30) Foreign Application Priority Data
Sep. 21, 2022 (DE) 102022124180.7

(51) Int. Cl. H02K 1/276; H02K 15/0273; H02K 15/035

(52) U.S. Cl. CPC H02K 1/276; H02K 15/0273; H02K 15/035; H02K 2201/06

(57) ABSTRACT

A rotor for an electric machine for use within the powertrain of a motor vehicle which is driven in a hybrid or fully electric manner is disclosed. The rotor is made of a plurality of rotor bodies made of stacked rotor laminations, and the rotor bodies are equipped with permanent magnets. The rotor bodies are rotated relative to one another about a common rotational axis, wherein the rotor hereby has an offset angle a which is defined by the total rotation of the rotor bodies, and each of the rotor laminations has at least one first offset hole through which a first rod-shaped tool can engage axially and by means of which the relative offset of two axially adjacent rotor bodies can be adjusted.

### CROSS-REFERENCE TO RELATED APPLICATION

The present application is the U.S. National Phase of PCT Patent Application Number PCT/DE 2023/100626, filed on Aug. 29, 2023, which claims priority to German Patent Application Number 10 2022 124 180.7, filed Sep. 21, 2022, the entire disclosures of which are incorporated by reference herein.

### TECHNICAL FIELD

The present disclosure relates to a rotor for an electric machine, in particular for use within a powertrain of a motor vehicle which is driven in a hybrid or fully electric manner, wherein the rotor is made of a plurality of rotor bodies made of stacked rotor laminations, and the rotor bodies are equipped with permanent magnets, wherein the rotor bodies are rotated relative to one another about a common rotational axis, wherein the rotor has an offset angle α which is defined by the total rotation of the rotor bodies. The disclosure also relates to a manufacturing assembly for producing a rotor, a method for producing a rotor and an electric machine.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort to which they are accustomed.

Permanently excited synchronous machines (PSM) are already used in many industrial applications and, in the course of electrification, increasingly also in the automotive industry. Such a permanently excited synchronous machine usually has a stator to be energized and a permanently excited rotor. Permanently excited synchronous motors are built both as internal rotors and as external rotors (stator arranged internally). In order to achieve the best possible synchronization properties, the electrical windings of the stator are divided into numerous winding sections, which are arranged one after the other in the circumferential direction according to the current phases used. Modern synchronous motors are often operated in a 3-phase electrical network, where high torques can be provided. In this case, the number of electrical sub-windings is a whole multiple of three. The number of magnetic poles formed on the rotor is adapted to the winding method of the electrical coils on the stator. The ratio between the number of poles on the rotor and the number of electrical poles formed on the stator also influences the synchronization properties of the motor. Two adjacent poles on the rotor each form a pole pair.

Due to the magnetic forces acting on the permanently excited synchronous motor, noticeable “cogging” occurs when the rotor is manually rotated in the de-energized state. More problematic for the running characteristics of such a synchronous motor, however, is a similar effect that occurs when the motor is energized and under load and is referred to in this context as load pulsation, torque fluctuation or “ripple torque”. The load pulsation is hardly noticeable when the motor is idling (when no or only a low torque is picked up) if the number of poles is sufficiently high. However, when the engine is operated with high torque reduction, the load pulsation is clearly noticeable as a periodic torque fluctuation. The torque fluctuation usually follows a sinusoidal oscillation, which corresponds to a higher harmonic of the torque change occurring at a pole pair.

Since such load pulsation is disruptive in many applications, in particular when high synchronization properties are required, there are various approaches in the prior art to reduce load pulsation. For example, attempts are made to counteract load pulsation by varying the current values fed into the motor in opposite directions. This type of electronic control can lead to a reduction in load pulsation in relatively slow-running engines and constant load reduction in very fast-acting control circuits. However, if the motor control system has to compensate for rapidly changing load conditions at high speeds, conventional control circuits are no longer able to simultaneously regulate the load pulsation with justifiable effort.

Another solution approach pursued in practical implementations is to reduce the load pulsation by inclining the poles of the rotor relative to the poles of the stator. In permanently excited synchronous motors, the permanent magnets arranged on the rotor are tilted in relation to the rotational axis. This inclination means that the entire cross sectional area of the poles does not face each other at any time, which leads to a reduction in the maximum torque on one hand but also has a leveling effect with regard to the load pulsation on the other hand.

Rotors for electric machines that have such reduced torque ripple are known from the prior art. For example, the website https://etn-demeter.eu/rotor-shaping-technologies-for-permanent-magnet-electrical-machines/ proposes different concepts for a rotor with reduced torque ripple.

A concept for reducing torque ripple known from the prior art as rotor skewing is that a rotor with a number of rotor segments arranged axially in a row and rotated against each other by an angle can each be rotated against each other by a certain angle.

Various rotor skewings are known. With linear skewing, the skewing of the magnetic poles of the same polarity runs linearly from a first rotor segment in the axial direction to a last rotor segment. V-shaped rotor skewing is also known, in which the course of the magnetic poles resembles a V-shape.

The rotors of electric motors are in many cases assembled using rotor laminations or rotor lamination stacks. As already explained above, for the electric motor to function correctly, a defined offset or relative angular position of the rotor laminations or rotor lamination stacks to one another is of eminent importance for harmonious synchronization of the electric machine. Therefore, when assembling the rotor, this offset must be set reliably and correctly and the rotor laminations or rotor lamination stacks must be joined to the rotor shaft of the rotor with this specified offset. Furthermore, it should be ensured that the offset, once correctly set, is maintained even when the electric motor is operating.

It is known from DE 102018112195 A1 that, for anchoring to one another, there are cup-shaped or hat-shaped openings in the rotor laminations, preferably all rotor laminations, which have depressions on one side of the rotor lamination and elevations on the other side of the rotor lamination, the dimensions of which are coordinated with one another for fastening to one another. This means that the presence of the recesses or elevations on the respective sides of the rotor laminations simplifies the implementation of the offset of the individual rotor laminations/rotor lamination stacks with each other There is a continuing need to reduce the torque ripple of rotors by means of rotor skewing.

However, in the conventional processes for jointing the lamination stacks, these are usually heated, for example during plastic injection molding processes, which causes them to expand thermally. As a result, it may not be possible to comply with the required tolerances for the rotation of the individual rotor lamination stacks in relation to one another.

### SUMMARY

The object of the disclosure is therefore to provide a rotor in which the torque ripple can be reduced, thus increasing the smooth running and service life of the rotor. It is also the object of the disclosure to realize a rotor that can be produced cost-effectively and which can ensure the highest possible accuracy when the individual rotor lamination stacks are rotated relative to one another. Furthermore, the object of the disclosure is to realize an improved manufacturing assembly for producing a rotor and an optimized method for producing a rotor. It is also the object of the disclosure to provide an electric machine that is very quiet when running and that can be produced cost-effectively.

The object is achieved by a rotor for an electric machine, in particular for use within a powertrain of a motor vehicle which is driven in a hybrid or fully electric manner, wherein the rotor is made of a plurality of rotor bodies made of stacked rotor laminations, and the rotor bodies are equipped with permanent magnets, wherein the rotor bodies are rotated relative to one another about a common rotational axis, wherein the rotor has an offset angle α which is defined by the total rotation of the rotor bodies, wherein each of the rotor laminations has at least one first offset hole through which a first rod-shaped tool can engage axially and by means of which the relative offset of two axially adjacent rotor bodies can be adjusted, and the first offset holes are arranged in the rotor in a flush manner relative to one another such that a first channel is formed extending axially through the rotor, wherein the first offset holes have a contour which deviates from a circular shape and has a longitudinal extension in the radial direction.

This has the advantage that the rotor laminations can be positioned with sufficient precision in the circumferential direction in order to meet with the required tolerances for the rotation between the lamination stacks. Furthermore, the lamination stacks can be easily joined and the different linear expansions at different temperatures of the lamination stacks and the tool can be compensated. The rotors according to the disclosure thus have an offset hole pattern in the rotor laminations, by means of which the offset of the rotor bodies can be very precisely defined.

First, the individual elements of the claimed subject matter of the disclosure are explained in the order of their relevance or their mention in the claims, and then particularly preferred embodiments of the subject matter of the disclosure are described.

A rotor is the rotating (spinning) part of an electric machine. The rotor particularly comprises a rotor shaft and one or more rotor bodies formed of rotor lamination stacks which are arranged on the rotor shaft in a non-rotatable manner. The rotor shaft can be hollow, which on the one hand results in weight savings and on the other hand allows the supply of lubricant or coolant to the rotor body.

A rotor body for the purposes of the disclosure is understood to mean the rotor without a rotor shaft. The rotor body is therefore made in particular of a rotor lamination stack and the permanent magnets inserted into the pockets of the rotor lamination stack or fixed to the circumference of the rotor lamination stack, as well as any axial cover parts for closing the pockets.

The permanent magnets can preferably be inserted into the pockets of the rotor lamination stack. A single larger rotor magnet designed as a bar magnet or a plurality of smaller permanent magnetic elements can be provided for each pocket.

The rotor has a plurality of rotor bodies. Particularly preferably, the rotor bodies are formed substantially of the same parts, in particular substantially identically. It is highly preferred that the rotor bodies are formed from identical, in particular substantially identical rotor laminations. The rotor bodies are therefore particularly preferably formed from a rotor lamination stack, which is composed of a plurality of laminated individual sheets or rotor laminations, usually made of electrical steel, which are layered and stacked one above the other to form a stack, what is termed the rotor lamination stack. The individual laminations can be held together in the rotor lamination stack by gluing, welding, or screwing. A rotor lamination stack can in particular also have permanent magnets that are inserted into the pockets of the rotor lamination stack, or that are fixed circumferentially to the rotor lamination stack.

The rotor according to the disclosure is intended for use in an electric machine. An electric machine is usually used to convert electrical energy into mechanical energy and/or vice versa. Electric machines generally comprise a stationary part referred to as a stator or armature, and a part referred to as a rotor arranged to be movable relative to the stationary part.

In the case of electric machines designed as rotary machines, a distinction is drawn in particular between radial flux machines and axial flux machines. A radial flux machine is characterized in that the magnetic field lines extend in the radial direction in the air gap formed between rotor and stator, while in the case of an axial flux machine the magnetic field lines extend in the axial direction in the air gap formed between rotor and stator. In connection with the disclosure, the rotor according to the disclosure is preferably intended for use in a radial flow machine. The stator of a radial flux machine usually has a cylindrical structure and generally consists of electrical laminations that are electrically insulated from one another and are structured in layers and stacked to form lamination stacks. Distributed over the circumference, grooves or circumferentially closed recesses are embedded into the electrical lamination running parallel to the rotor shaft, and accommodate the stator winding or parts of the stator winding. Depending on the construction towards the surface, the grooves can be closed with closing elements, such as closing wedges or covers or the like, to prevent the stator winding from detaching.

The rotor according to the disclosure is intended in particular for use in an electric machine within a powertrain of a motor vehicle which is driven in a hybrid or fully electric manner.

In particular, the electric machine is dimensioned such that vehicle speeds of more than 50 km/h, preferably more than 80 km/h, and in particular more than 100 km/h can be achieved. The electric motor particularly preferably has an output of more than 30 KW, preferably more than 50 kW, and in particular more than 70 kW. Furthermore, it is preferred that the electric machine provides speeds greater than 5000 rpm, particularly preferably greater than 10,000 rpm, very particularly preferably greater than 12,500 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

In the context of this application, the powertrain of a motor vehicle is understood to mean all components that generate the power for driving the motor vehicle in the motor vehicle and transmit it to the road via the vehicle wheels.

According to a further preferred development of the disclosure, it can also be provided that the offset holes are arranged on a common pitch circle D1 positioned coaxially to the rotor.

Advantageous embodiments of the disclosure are specified in the dependent claims. The features listed individually in the dependent claims can be combined with one another in a technologically meaningful manner and can define further embodiments of the disclosure. In addition, the features indicated in the claims are specified and explained in more detail in the description, wherein further preferred embodiments of the disclosure are shown.

According to an advantageous embodiment of the disclosure, it can be provided that each of the rotor laminations has at least one second offset hole through which a second rod-shaped tool can engage axially and by means of which the relative offset of two axially adjacent rotor bodies can be adjusted, and the second offset holes are arranged in the rotor in a flush manner relative to one another such that a second channel is formed extending axially through the rotor, wherein the second offset holes have a contour which deviates from a circular shape and has a longitudinal extension in the radial direction.

The advantage of this design is that a geometrically unique arrangement of a rotor lamination can be defined by two offset holes.

Most preferably, the first and second offset holes are arranged offset by 180° from each other on a common pitch circle D1, which allows a particularly good compensation of thermal expansions within the stator laminations.

According to a further preferred further development of the disclosure, it can also be provided that the first offset holes and/or the second offset holes of the rotor laminations are designed to be substantially identical, which is particularly favorable in terms of manufacturing technology.

Furthermore, according to an equally advantageous embodiment of the disclosure, it can be provided that the first offset holes and/or second offset holes are designed as elongated holes, wherein the elongated hole has a substantially rectangular section, to which a semicircular section adjoins on both sides in the radial direction. This design has proven to be particularly advantageous for the production of offset rotors.

According to a further particularly preferred embodiment of the disclosure, it can be provided that the rectangular section has a length L in the radial direction and the semicircular sections each have a diameter DS, wherein the length L is between L=0.1*DS and L=0.2*DS. This makes it possible to achieve the effect that very precise tolerances can be maintained in the circumferential direction, while sufficient space is maintained in the radial direction to compensate for thermal material expansion.

It is further preferred that the radial extension of the elongated hole is smaller than 0.1*(D1+DS), whereby a sufficiently good thermal expansion compensation can be provided.

The object of the disclosure can be further achieved by a manufacturing assembly for producing a rotor according to any one of claims 1-5, comprising a first rod-shaped tool, and a plurality of rotor bodies made of stacked rotor laminations, wherein the rotor bodies are equipped with permanent magnets and rotated relative to one another about a common rotational axis, wherein the rotor has an offset angle α which is defined by the total rotation of the rotor bodies, wherein each of the rotor laminations has at least one first offset hole through which the first rod-shaped tool can engage axially and by means of which the relative offset of two axially adjacent rotor bodies can be adjusted, and the first offset holes are arranged in the rotor in a flush manner relative to one another such that a first channel is formed extending axially through the rotor, wherein the first offset holes have a contour which deviates from a circular shape and has a longitudinal extension in the radial direction, and the rod-shaped first tool, when inserted into the first offset holes, engages through the first offset holes with play in the radial direction and substantially without play in the circumferential direction.

Furthermore, the object of the disclosure can also be achieved by a method for producing a rotor comprising the following steps:
providing a first rod-shaped tool and
providing a plurality of rotor bodies made of stacked rotor laminations, wherein the rotor bodies can be equipped with permanent magnets and can be rotated relative to one another about a common rotational axis, wherein the rotor has an offset angle α which is defined by the total rotation of the rotor bodies, wherein each of the rotor laminations has at least one first offset hole through which the first rod-shaped tool can engage axially and by means of which the relative offset of two axially adjacent rotor bodies can be adjusted, and the first offset holes are arranged in the rotor in a flush manner relative to one another such that a first channel is formed extending axially through the rotor, wherein the first offset holes have a contour which deviates from a circular shape and has a longitudinal extension in the radial direction,
pushing the rotor laminations through the first offset holes onto the rod-shaped first tool.

In this context, it may also be advantageous to further develop the method in such a way that the rotor laminations are pushed on at a rotor lamination temperature of 15° C.-35° C. Preferably, the first and the second tool have a temperature of 50-100° C., preferably 65-85° C., when the rotor laminations are pushed on. During molding, the rotor laminations and the tools are then preferably heated to a temperature between 150-200° C., preferably 160-180° C.

The object of the disclosure is also achieved by an electric machine, in particular for a powertrain of a motor vehicle which is driven in a hybrid or fully electric manner, comprising a rotor according to any one of claims 1-5.

The disclosure is explained in more detail below with reference to figures without limiting the general concept of the disclosure.

### BRIEF DESCRIPTION OF THE DRAWINGS

In the drawings:

FIG. 1 shows a schematic axial sectional view of an electric machine,

FIG. 2 shows a frontal view of a rotor lamination stack of a rotor,

FIG. 3 shows a detailed view of an offset hole,

FIG. 4 shows a perspective illustration of a manufacturing assembly for a rotor,

FIG. 5 shows a motor vehicle with an electric powertrain in a schematic block diagram.

### DETAILED DESCRIPTION

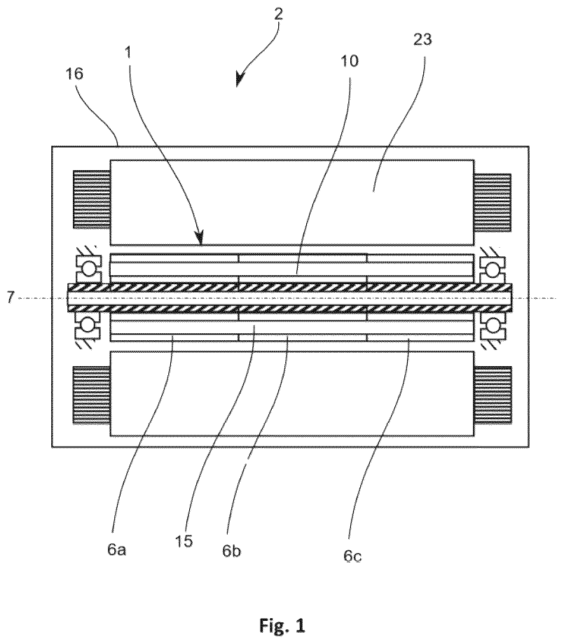

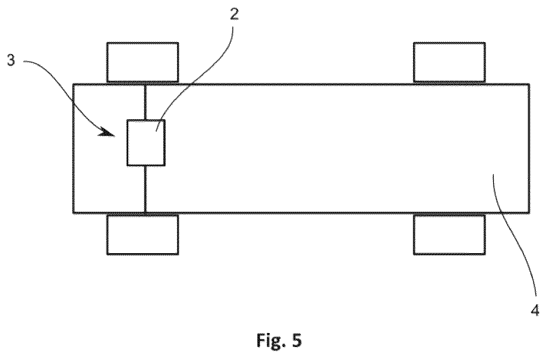

FIG. 1 shows a rotor 1 mounted for rotation relative to the stator 23 for an electric machine 2 for use within a powertrain 3 of a motor vehicle 4 which is driven in a hybrid or fully electric manner, as is also shown by way of example in FIG. 5. In the embodiment shown, the electric machine 2 is designed as a radial flux machine.

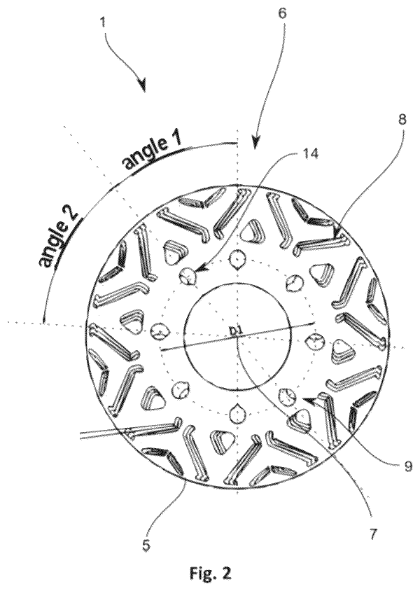

The rotor 1 is made of a three rotor bodies 6a, 6b, 6c made of stacked rotor laminations 5, and the rotor bodies 6a, 6b, 6c are equipped with permanent magnets 8, which can be seen from the combination with FIG. 2.

The rotor bodies 6a, 6b, 6c are rotated relative to one another about a common rotational axis 7, wherein the rotor 1 has an offset angle α which is defined by the total rotation of the rotor bodies 6.

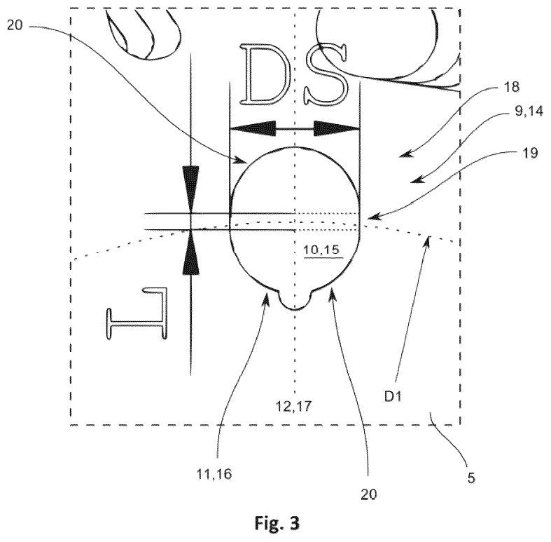

As can be seen from FIG. 2, each of the rotor laminations 5 has one first offset hole 9 through which a first rod-shaped tool 13 can engage axially and by means of which the relative offset of two axially adjacent rotor bodies 6 can be adjusted, and the first offset holes 9 are arranged in the rotor 1 in a flush manner relative to one another such that a first channel 10 is formed extending axially through the rotor 1, which can be seen from the combination of FIG. 2 and FIG. 3.

The first offset holes 9 have a contour 11 which deviates from a circular shape and which has a longitudinal extension 12 in the radial direction.

Furthermore, each of the rotor laminations 5 has at least one second offset hole 14 through which a second rod-shaped tool 21 can engage axially and by means of which the relative offset of two axially adjacent rotor bodies 6 can be adjusted, and the second offset holes 14 are arranged in the rotor 1 in a flush manner relative to one another such that a second channel 15 is formed extending axially through the rotor 1. The second offset holes 14 have a contour 16 which deviates from a circular shape and which has a longitudinal extension 17 in the radial direction.

The first offset holes 9 and the second offset holes 14 of the rotor laminations 5 are substantially identical and are arranged on a common pitch circle D1 positioned coaxially to the rotor 1.

The rotor offset of the individual rotor bodies 6a, 6b, 6c is thus effected by the offset holes 9, 14, which are arranged on a common pitch circle D1. Depending on the desired offset angle of the rotor 1, these are inserted at different angles (angle 1, angle 2) on the pitch circle D1 in the rotor bodies 6a, 6b, 6c. Since only individual offset holes are required to ensure the rotation of the stator bodies 6a, 6b, 6c, it is possible to design them as elongated holes 18, as can be seen in FIG. 2.

When designing the elongated holes 18, the width of the elongated hole 18 is designed with as little clearance for a tool 13, 21 as possible. The tolerance is determined here by the expansion of the tool 13, 21 under temperature and the manufacturing tolerances. The tolerance is in the range of <2.5% of the diameter of the circular tool 13, 21. The radial length of the elongated hole 18 is determined by the different thermal expansion of the base plate 24 with the tools 13, 21 and the rotor laminations 5. A radial extension of the elongated hole smaller than 0.1*(D1DS) has proven to be particularly advantageous.

In the embodiment shown, the first offset holes 9 and second offset holes 14 are designed as elongated holes 18, wherein the elongated hole 18 has a substantially rectangular section 19, to which a semicircular section 20 adjoins on both sides in the radial direction, as can be seen in FIG. 3. The rectangular section 19 has a length L in the radial direction and the semicircular sections 20 each have a diameter DS, wherein the length L is between L=0.1*DS and L=0.2*DS.

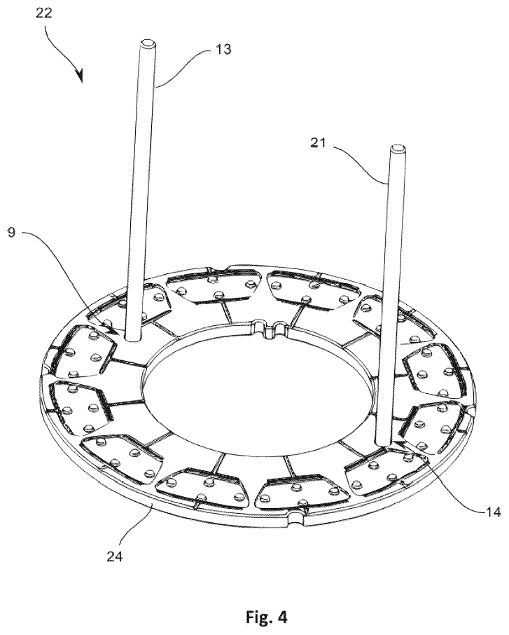

FIG. 4 shows a manufacturing assembly 22 for producing a rotor 1 as known from FIGS. 1-3. The manufacturing assembly 22 has a first rod-shaped tool 13 with a circular cross-section and a second rod-shaped tool 21 with a circular cross-section. In the embodiment shown, the first tool 13 and the second tool 21 are substantially identical. The diameter of the tools 13, 21 is selected such that the tools 13, 21 can penetrate the offset holes 9,14. The tools 13, 21 extend orthogonally out of the plane of a base plate 24, so that the rotor laminations 5 rest on this base plate 24 when they are placed over the tools 13, 21 by means of the offset holes 9, 14.

Using the manufacturing assembly 22, a rotor 1 can be produced as follows:

Firstly, a first and a second rod-shaped tool 13, 21 are provided, as shown in FIG. 4. Then, a plurality of rotor bodies 6 made of stacked rotor laminations 5 is provided, wherein the rotor bodies 6 can be equipped with permanent magnets 8 and can be rotated relative to one another about a common rotational axis 7, wherein the rotor 1 has an offset angle α which is defined by the total rotation of the rotor bodies 6. The rotor laminations 5 correspond to those shown in FIGS. 2-3. These rotor laminations 5 are then pushed through the first offset holes 9, 14 onto the rod-shaped tools 13, 21.

The rotor laminations 5 are pushed on at a rotor lamination 5 temperature of 15° C.-35° C.. Preferably, the first and the second tool 13, 21 have a temperature of 50-100° C., preferably 65-85° C., when the rotor laminations 5 are pushed on. During molding, the rotor laminations 5 and the tools 13, 21 are then preferably heated to a temperature between 150-200° C., preferably 160-180° C.

The terms “radial,” “axial,” “tangential” and “circumferential direction” used in this application always refer to the rotational axis of the rotor of the electric machine. The terms “left,” “right,” “above,” “below,” “over,” and “under” are used here only to clarify which areas of the illustrations are currently being described in the text. The later embodiment of the disclosure may also be arranged differently. The disclosure is also not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define “first” and “second” features, this designation serves to distinguish between two features of the same type without defining an order of precedence.

### List of Reference Symbols

1 Rotor
2 Electric machine
3 Powertrain
4 Motor vehicle
5 Rotor lamination
6 Rotor body
7 Rotational axis
8 Permanent magnet
9 Offset hole
10 Channel
11 Contour
12 Longitudinal extension
13 Tool
14 Offset hole
15 Channel
16 Contour
17 Longitudinal extension
18 Elongated hole
19 Section
20 Section
21 Tool
22 Manufacturing assembly
23 Stator
24 Base plate

1. A rotor for an electric machine for use within a powertrain of a motor vehicle driven in a hybrid or fully electric manner, the rotor comprising:
a plurality of rotor bodies made of stacked rotor laminations,
wherein the rotor bodies include permanent magnets,
wherein the rotor bodies are rotated relative to one another about a common rotational axis,
wherein the rotor has an offset angle defined by a total rotation of the rotor bodies,
wherein each of the rotor laminations includes at least one first offset hole through which a first rod-shaped tool engages axially and adjusts the relative offset of two axially adjacent rotor bodies,
wherein the first offset holes are flush relative to one another such that a first channel is formed extending axially through the rotor,
wherein the first offset holes have a contour which deviates from a circular shape and has a longitudinal extension in the radial direction.

2. The rotor according to claim 1, wherein each of the rotor laminations has at least one second offset hole through which a second rod-shaped tool can engage axially and by means of which the relative offset of two axially adjacent rotor bodies can be adjusted, and the second offset holes are arranged in the rotor in a flush manner relative to one another such that a second channel is formed extending axially through the rotor,
wherein the second offset holes have a contour which deviates from a circular shape and has a longitudinal extension in the radial direction.

3. The rotor according to claim 2, wherein the first offset holes and/or the second offset holes of the rotor laminations are substantially identical.

4. The rotor according to claim 2, wherein the first offset holes and/or second offset holes are designed as elongated holes, wherein the elongated hole has a substantially rectangular section, to which a semicircular section adjoins on both sides in the radial direction.

5. The rotor according to claim 4, wherein the rectangular section has a length L in the radial direction and the semicircular sections each have a diameter DS, wherein the length L is between L=0.1*DS and L=0.2*DS.

6. A manufacturing assembly for producing a rotor according to claim 1,
wherein the first rod-shaped tool, when inserted into the first offset holes, engages through the first offset holes with play in the radial direction and substantially without play in the circumferential direction.

7. A method for producing a rotor , comprising the following steps:
providing a first rod-shaped tool;
providing a plurality of rotor bodies made of stacked rotor laminations, wherein the rotor bodies include permanent magnets and are rotatable relative to one another about a common rotational axis, wherein the rotor has an offset angle defined by the total rotation of the rotor bodies, wherein each of the rotor laminations has at least one first offset hole through which the first rod-shaped tool can engage axially and by means of which the relative offset of two axially adjacent rotor bodies can be adjusted, and the first offset holes are arranged in the rotor in a flush manner relative to one another such that a first channel is formed extending axially through the rotor, wherein the first offset holes have a contour which deviates from a circular shape and has a longitudinal extension in the radial direction; and
pushing the rotor laminations through the first offset holes onto the first rod-shaped tool.

8. The method according to claim 7, wherein the rotor laminations are pushed on at a rotor lamination temperature of 15-35° C.

9. The method according to claim 7, wherein the first rod-shaped tool has a temperature of 50-100° C., when the rotor laminations are pushed on.

10. An electric machine for use within a powertrain of a motor vehicle driven in a hybrid or fully electric manner, comprising a rotor according to claim 1.

11. A rotor for an electric machine comprising:
a plurality of rotor bodies made of stacked rotor laminations,
wherein the rotor bodies are rotatable relative to one another about a common rotational axis,
wherein each of the rotor laminations includes at least one first offset hole through which a first rod-shaped tool engages axially and adjusts a relative offset of two axially adjacent rotor bodies,
wherein the first offset holes are flush relative to one another such that a first channel is formed extending axially through the rotor,
wherein the first offset holes have a contour deviating from a circular shape and a longitudinal extension in the radial direction.
wherein each of the rotor laminations includes at least one second offset hole through which a second rod-shaped tool can engage axially and adjusts a relative offset of two axially adjacent rotor bodies,
wherein the second offset holes are flush relative to one another such that a second channel is formed extending axially through the rotor,
wherein the second offset holes have a contour deviating from a circular shape and a longitudinal extension in the radial direction.

12. The rotor according to claim 11, wherein the rotor bodies include permanent magnets.

13. The rotor according to claim 11, wherein the rotor has an offset angle defined by a total rotation of the rotor bodies.

14. The rotor according to claim 11, wherein at least one of the first offset holes or the second offset holes are substantially identical.

15. The rotor according to claim 11, wherein at least one of the first offset holes or the second offset holes are elongated and include a rectangular section, wherein a semicircular section adjoins the rectangular section on both sides in a radial direction.

16. The rotor according to claim 15, wherein the rectangular section has a length L in the radial direction and the semicircular sections each have a diameter DS, wherein the length L is between L=0.1*DS and L=0.2*DS.
